(19) United States
(12) Patent Application Publication
(10) Pub. No.: US 2006/0267314 A1
(43) Pub. Date: Nov. 30, 2006

(54) Airbag apparatus for vehicle and airbag cover

(75) Inventors: Mitsuo Yasuda, Nanto-shi (JP); Ryoichi Katagishi, Nanto-shi (JP); Yusuke Ishikuro, Nanto-shi (JP)

Correspondence Address: ROTH & GOLDMAN, P.A., 523 W. 6TH STREET, SUITE 707, LOS ANGELES, CA, 90014, US

(73) Assignee: SANKO GOSEI Kabushiki Kaisha, Nanto-shi (JP)

(21) Appl. No.: 11/442,079

(22) Filed: May 25, 2006

(30) Foreign Application Priority Data
May 31, 2005 (JP) 2005-160249

(51) Int. Cl. B60R 21/205; B60R 21/215

(52) U.S. Cl. 280/728.3; 280/732; 280/728.2

(57) ABSTRACT

An airbag cover includes a panel member composed of a substrate, a foam layer, and a surface layer. A fracture groove is formed on the reverse surface of the panel member so as to define in a fracture-opening section thereof two fracture-opening subsections openable in the manner of a casement. The fracture groove has a depth corresponding to the thickness of the substrate or a depth slightly greater than the thickness of the substrate. This configuration prevents generation of sink marks or depressions on the surface of the cover. The fracture groove is composed of a straight center fracture groove section, two V-shaped branch fracture groove sections extending from the opposite ends of the center fracture groove section, and side fracture groove sections extending from distal ends of the V-shaped branch fracture groove sections in opposite directions perpendicularly to the center fracture groove section.

### BACKGROUND OF THE INVENTION

1. Field of the Invention

The present invention relates to an airbag apparatus for a vehicle and to an airbag cover for covering the airbag apparatus. More particularly, the invention relates to an airbag cover which has a surface layer and a foam layer and which has a fracture groove for deployment of an airbag and to an airbag apparatus for a vehicle which utilizes such an airbag cover.

The term “fracture groove” used in relation to the present invention refers to a weakened portion or a fracture portion for fracture opening which is composed of successive holes formed on the reverse or inside surface of an interior panel of a vehicle through irradiation with a laser beam generated from laser generation means in the form of laser pulses, or a groove continuously or intermittently formed on the reverse or inside surface of the interior panel by use of a cutting tool or the like.

2. Description of the Related Art

There has been known an airbag apparatus for a vehicle for protecting a person in a vehicle such as an automobile; for example, a driver or a passenger sitting in the front passenger seat, from impact upon head-on or side collision of the vehicle. Such an airbag apparatus includes an airbag, an airbag case for accommodating the airbag folded such that the airbag can easily inflate and deploy, and an inflater for inflating the folded airbag within a short period of time. In particular, an airbag apparatus which is used for the front passenger seat is disposed behind an airbag cover, which forms an interior panel or the like. When the automobile decelerates suddenly because of, for example, a collision, the inflater is operated so as to rapidly inflate the airbag, to thereby rupture and open the interior panel along the fracture groove and cause the airbag to inflate and deploy toward the outside of the airbag cover. Thus, the airbag apparatus protects the passenger from impact of the collision.

The fracture groove for causing the airbag of the airbag apparatus to inflate and deploy toward the outside of the airbag cover is formed by forming successive small hole's on the reverse surface of the interior panel through irradiation with a laser beam (see, for example, Japanese Patent Application Laid-Open (kokai) No. 2005-22453.

A conventional airbag apparatus for a vehicle will be described with reference to FIG. 1, FIG. 2, and FIGS. 3A and 3B.

An airbag cover 10 shown in FIG. 1 corresponds to an interior cover of a vehicle, and is formed into a three-dimensionally covered plate. As shown in FIGS. 3A and 3B, the airbag cover 10 has a three-layer structure; i.e., includes a substrate 101 formed of hard, polypropylene (PP) and having a thickness of 3 mm to 4 mm; a foam layer 102 layered over and bonded to the surface of the substrate 101, formed of foamed polypropylene, and having a thickness of 1.5 mm to 2 mm; and a surface layer 103 layered over and bonded to the surface of the foam layer 102, formed of thermoplastic polyolefin (TPO), and having a thickness of 0.6 mm to 1 mm.

As shown in FIGS. 1 and 2, a fracture groove 11 (indicated by a thick broken line) is formed on the reverse surface of the airbag cover 10 so as to enable an airbag to inflate and deploy to the outside of the airbag cover 10. The fracture groove 11 is composed of a single first fracture groove 11a extending in the longitudinal direction, and two second fracture grooves 11b connected to the opposite ends of the first fracture groove 11a and extending perpendicular to the first fracture groove 11a. These fracture grooves 11a and 11b form a generally H-like shape as viewed from above.

In elongated regions between the opposite ends 11b1 of the left-hand second fracture groove 11b and the opposite ends 11b2 of the right-hand second fracture groove 11b, the thickness of the airbag cover 10 is made smaller than the remaining regions through removal of the material from the reverse surface of the airbag cover 10, to thereby form hinge portions 15 of fracture-opening subsections 14 (indicated by two-dot chain lines), which are formed as a result of fracture of the fracture groove 11.

As shown in FIGS. 3A and 3B, the first and second fracture grooves 11a and 11b are formed by forming successive small holes (blind holes) 16 on the reverse surface of the airbag cover 10 through irradiation with an infrared laser beam having a beam diameter of 0.2 to 0.5 mm and a wavelength of 10.6 μm, in such a manner that the small holes pass through the substrate 101 and the foam layer 102 and reach the surface layer 103.

A flange portion 13A of a frame 13 is bonded, by means of vibration welding or any other suitable process, to the reverse surface of the airbag cover 10. The frame 13 is formed of PP or TPO and has a size sufficient to surround the fracture groove 11.

Reinforcement members (not shown) formed of PP or TPO are attached to the inner wall of the frame 13 so as to enhance the mechanical strength of a portion of the airbag cover 10 corresponding to the areas surrounded by the first fracture groove 11a, the second fracture grooves 11b, and the hinge portions 15. Portions of the reinforcement members are bonded, by means of vibration welding or any other suitable process, to the reverse surface of the airbag cover 10 in the above-mentioned areas. Moreover, an airbag apparatus including an airbag, an airbag case, and an inflater, which are not shown, is attached to the frame 13.

The thus-configured conventional airbag apparatus functions in the following manner. Upon collision of the vehicle, an impact force caused by the collision is detected by a sensor. A control unit including a CPU judges whether or not the detected impact force is equal to or greater than a predetermined value. When the control unit judges that the impact force is equal to or greater than the predetermined value, the control unit issues a signal for causing the inflater to generate a high-pressure gas. The gas is fed to the airbag so as to promptly inflate the airbag. The inflating airbag presses, from inside, the airbag cover 10 in the regions surrounded by the fracture groove 11 and the hinges 15. As a result, the airbag cover 10 is ruptured along the first and second fracture grooves 11a and 11b.

The fracture-opening subsections 14, formed as a result of the rupture of the airbag cover 10, are opened in the manner of a casement (French window), while being turned about hinge portions 15. As a result, the airbag inflates and deploys to the outside of the airbag cover 10. Serving as a cushion, the inflated airbag supports the passenger at his/her chest or head, thereby protecting the passenger from the impact force of collision.

However, the above-described conventional airbag cover 10 has the following drawback. Since the hinge portions 15 of the fracture-opening subsections 14, which are opened when the airbag cover 10 is ruptured along the fracture groove 11 upon inflation of the airbag, are thinner than the remaining portions, sink marks are produced on the substrate 101 at locations corresponding to the hinge portions 15, whereby sink marks or concave portions are formed on the outer surface of the airbag cover 10. As a result, the appearance of the airbag cover 10 is impaired, and the aesthetic effect is deteriorated.

Moreover, in the conventional airbag cover 10, since the small holes 16, which constitute the first and second fracture grooves 11a and 11b are formed in such a manner that they pass through the substrate 101 and the foam layer 102 and reaches the surface layer 103, as shown in FIG. 3B, a high-temperature gas produced when a laser beam passes through the foam layer 102 melts neighboring portions of the foam layer 102, so that a relatively large cavity is produced between the substrate 101 and the surface layer 103 around each hole 16.

Therefore, the conventional airbag cover 10 has the following problem. When the flange portion of the frame and the reinforcement members are vibration-welded to the reverse surface of the airbag cover 10, the foam layer 102 interposed between the substrate 101 and the surface layer 103 is compressed and deformed, and undulations are formed on the outer surface of the airbag cover 10, whereby the appearance of the airbag cover 10 is deteriorated.

### SUMMARY OF THE INVENTION

In view of the foregoing, an object of the present invention is to provide an airbag cover which can prevent generation of sink marks or depressions on the surface of the cover during attachment of components of an airbag apparatus to the airbag cover.

Another object of the present invention is to provide an airbag cover which secures reliable opening of fracture-opening subsections formed when the airbag cover is ruptured along the fracture grooves upon inflation of an airbag, to thereby facilitate deployment of the airbag toward the outside of the airbag cover.

Still another object of the present invention is to provide an airbag apparatus for a vehicle which employs an airbag cover according to the present invention.

In order to achieve the above objects, the present invention provides an airbag cover including a panel member for covering an airbag, comprising a substrate formed of a resin; a foam layer formed of a resin and layered over and bonded to a surface of the substrate; a surface layer layered over and bonded to a surface of the foam layer. The panel member has a fracture-opening section of an area required for inflation and deployment of the airbag. A fracture groove is formed in the fracture-opening section so as to define two fracture-opening subsections which can be opened in the manner of a casement, the fracture groove being formed on a reverse surface of the substrate and having a depth corresponding to the thickness of the substrate or a depth slightly greater than the thickness of the substrate. The fracture groove is composed of a straight center fracture groove section for dividing the fracture-opening section into the fracture-opening subsections, first side fracture groove sections extending from the opposite ends of the center fracture groove section in a first direction perpendicularly to the center fracture groove section, and second side fracture groove sections extending from the opposite ends of the center fracture groove section in a second direction opposite the first direction. First and second hinge grooves for pivotal motion of the fracture-opening subsections are formed on the reverse surface of the substrate such that the first hinge groove extends between the ends of the first side fracture groove sections and the second hinge groove extends between the ends of the second side fracture groove sections, each of the first and second hinge grooves having a depth less than that of the fracture groove.

By virtue of the above-described configuration, even through the fracture groove is not formed in the foam layer and the surface layer, by means of rupture corner portions of the substrate ruptured along the fracture groove and the impact force acing on the fracture-opening subsections upon inflation of the airbag, the foam layer and the surface layer can be readily ruptured along the fracture groove. In addition, the opening of the fracture-opening subsections in the manner of a casement upon inflation of the airbag can be reliably performed in a well-balanced manner, and generation of a crack or breakage of the airbag cover, which would otherwise occur upon inflation of the airbag, can be prevented. In particular, the above-described effect can be achieved without fail through employment of reinforcement members, which reinforce the fracture-opening section from the reverse surface side of the plate member. Moreover, since the fracture groove is not required to from in the foam layer and the surface layer of the panel member, no sink or depression is formed on the surface of the surface layer of the airbag cover. Therefore, the appearance of the airbag cover 22 is improved, and the aesthetic effect is improved.

Preferably, the fracture groove further includes two branch fracture groove sections extending from the opposite ends of the center fracture groove section and assuming a V-like shape; and the first and second side fracture groove sections extend from distal ends of the V-shaped branch fracture groove sections. In this case, at the opposite ends of the center fracture groove section, the fracture-opening subsections are ruptured along Y-shaped lines formed by the V-shaped branch fracture groove sections and the side fracture groove sections, so that the foam layer and the surface layer are ruptured along Y-shaped lines at the opposite ends of the center fracture groove section. Therefore, the airbag can readily deploy without fail toward the outer side of the cover when the fracture-opening subsections open in the manner of a casement.

Preferably, the fracture groove and the hinge grooves are each composed of a plurality of small holes successively formed on the reverse surface of the substrate through irradiation with a laser beam. More preferably, small holes constituting the fracture groove adjoin to each other and have a depth corresponding to the thickness of the substrate or a depth slightly greater than the thickness of the substrate; and small holes constituting the hinge grooves are separated from each other and have a depth about half the thickness of the substrate.

Preferably, the center fracture groove section is offset from the boundary between the fracture-opening subsections toward one of the fracture-opening subsection, so that the area of the other fracture-opening subsection becomes larger than that of the one fracture-opening subsection. This configuration enables the airbag to inflate and deploy to a direction inclined toward the fracture-opening subsection having a smaller area.

Preferably, a central portion of the center fracture groove section with respect to the longitudinal direction has a depth slightly greater than the thickness of the substrate, and the remaining portions of the center fracture groove section have a depth corresponding to the thickness of the substrate. In this case when the airbag inflates, the panel member starts to rupture from the central portion of the center rupture groove section, so that the panel member can be equally ruptured toward the left and right.

The present invention further provides an airbag apparatus for a vehicle comprising an airbag; an airbag cover according to the present invention which is composed of a panel member formed of a resin and adapted to cover the airbag; an airbag case disposed behind the airbag cover and accommodating the airbag in a folded condition; an inflater for supplying a gas to the airbag so as to inflate and deploy the airbag; a frame formed of a resin and fixed to a reverse surface of the panel member, the frame surrounding a fracture-opening section of the panel member which section has an area required for inflation and deployment of the airbag, and supporting the airbag case; and a pair of reinforcement members formed of a resin, the reinforcement member being supported by the frame and reinforcing the fracture-opening section from the reverse surface side thereof.

In this case, preferably, the frame and the reinforcement members are vibration-welded to the reverse surface of the substrate before the foam layer and the surface layer are layered over and bonded to the substrate. In this case, damage to the foam layer of the panel member is prevented.

### BRIEF DESCRIPTION OF THE DRAWINGS

Various other objects, features and many of the attendant advantages of the present invention will be readily appreciated as the same becomes better understood by reference to the following detailed description of the preferred embodiments when considered in connection with the accompanying drawings, in which:

FIG. 1 is a perspective view of a conventional airbag cover;

FIG. 2 is a plan view of the airbag cover shown in FIG. 1;

FIG. 3A is an enlarged cross-sectional view of the airbag cover taken along line 3-3 of FIG. 2;

FIG. 3B is an enlarged view of a portion of FIG. 3A;

FIG. 4 is a vertical sectional view of a main portion of an airbag apparatus for a vehicle which employs an airbag cover according to a first embodiment of the present invention;

FIG. 5 is a plan view of the airbag apparatus of FIG. 4 as viewed in the direction of arrow 5;

FIG. 6A is an enlarged cross-sectional view of the airbag cover taken along line 6-6 of FIG. 5;

FIG. 6B is an enlarged cross-sectional view of the airbag cover taken along line 6-6 of FIG. 5;

FIG. 7 is an enlarged cross-sectional view of the airbag cover taken along line 7-7 of FIG. 5;

FIG. 8 is a perspective view of the airbag cover according to the first embodiment, showing its fracture-opening subsections;

FIG. 9 is an explanatory view of the airbag cover according to the first embodiment showing the relation between the fracture-opening subsections and the surface layer at the time when the fracture-opening subsections are opened; and

FIG. 10 is a vertical sectional view of a main portion of an airbag apparatus for a vehicle which employs an airbag cover according to a second embodiment of the present invention.

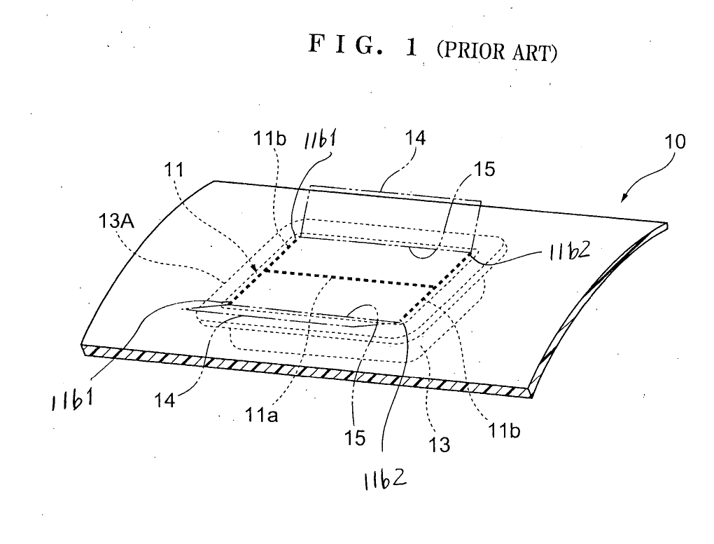

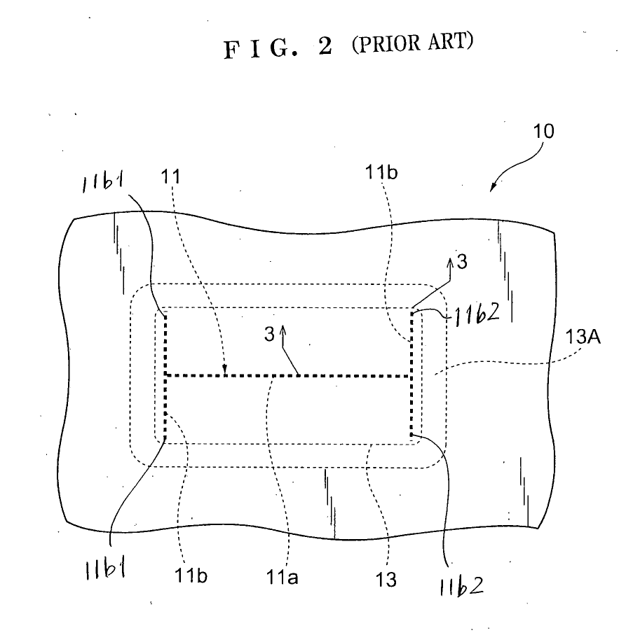

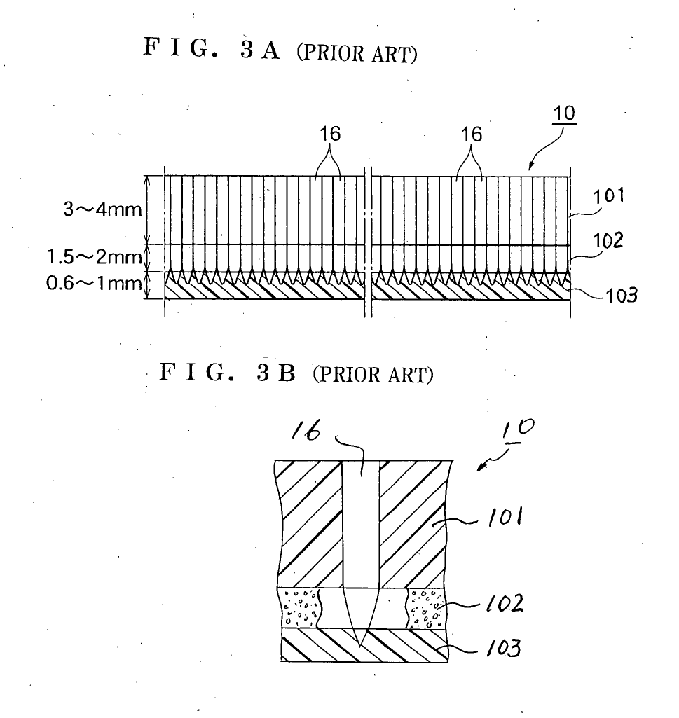

### DESCRIPTION OF THE PREFERRED EMBODIMENTS

Next, there will be described embodiments of the present invention in which an airbag apparatus employing an airbag cover according to the present invention is provided in front of a front passenger seat of an automobile.

### First Embodiment

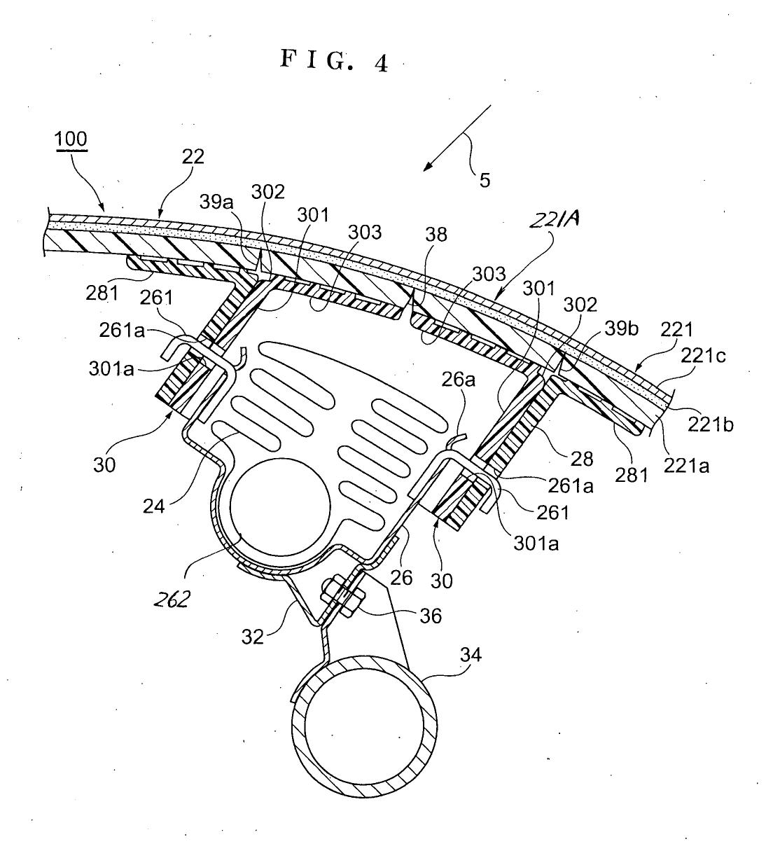

An airbag cover according to the first embodiment and an airbag apparatus employing the airbag cover will be described with reference to FIGS. 4 to FIG. 8.

As shown in FIG. 4, an airbag apparatus 100 for a vehicle includes an airbag cover (interior panel cover) 22, an airbag 24, an airbag case 26, a frame 28, a pair of reinforcement members 30, an unillustrated inflater, etc.

The airbag cover 22 is composed of a panel member 221 formed of a synthetic resin. The panel member 221 is formed into a three-dimensionally curved shape for covering the airbag 24 and covering an interior panel core (not shown) formed of a synthetic resin, and is secured to the interior panel core by means of, for example, tapping screws.

As shown in FIGS. 4, 6, and 7, the panel member 221 includes a substrate 221a formed of hard polypropylene (PP) and having a thickness of 3 mm to 4 mm; a foam layer 221b layered over and bonded to the surface of the substrate 221a, formed of foamed polypropylene, and having a thickness of 1.5 mm to 2 mm; and a surface layer 221c layered over and bonded to the surface of the foam layer 221b, formed of thermoplastic polyolefin (TPO), and having a thickness of 0.6 mm to 1 mm.

As shown in FIG. 4, the airbag 24 is accommodated in a folded condition within the airbag case 26 formed from a metallic plate material.

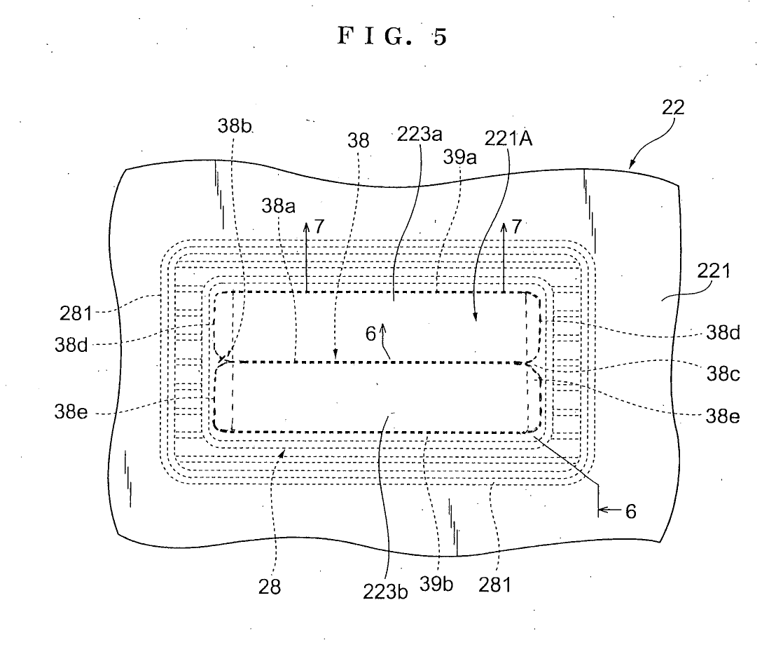

As shown in FIGS. 4 and 5, the frame 28 holds the airbag case 26 and the reinforcement members 30 on the reverse surface side of the airbag cover 22. The frame 28 is formed of a highly elastic, polypropylene-based resin material containing a reinforcing material such as talc and glass fiber in an amount of 10 to 30% by weight, and assumes the form of a rectangular tube having a transverse cross sectional area which corresponds to a rectangular fracture-opening section 221A of an area required to inflate and deploy the airbag 24. A joint flange 281 is integrally formed at the upper end of the frame 28 near the panel member 221, and is bonded, by means of vibration welding or any other suitable process, to the reverse surface of the substrate 221a of the panel member 221.

As shown in FIGS. 4 and 5, the paired reinforcement members 30 reinforce the fracture-opening section 221A of the panel member 221 from the reverse side thereof, and are formed of a synthetic resin such as polypropylene (PP) or thermoplastic polyolefin (TPO). Each of the reinforcement members 30 includes a support portion 301 coupled with the inner wall surface of the frame 28 via a dovetail; and a reinforcement portion 303 which is connected via a hinge portion 302 to the upper end of the support portion 301 in a bendable manner and is bonded to the reverse surface of the fracture-opening section 221A by means of vibration welding or any other suitable process.

A plurality of hooks 261 are provided on the side wall portions of the airbag case 26 in the vicinity of an upper end opening 26a thereof, the side wall portions facing the support portions 301 of the corresponding reinforcement members 30. The hooks 261 are engaged with square holes 301a formed in the support portions 301 and holes 261a formed in the frame 28 to correspond to the holes 301a, whereby the airbag case 26 is secured to the frame 28. An inflator accommodation portion 262 is provided at the lower end of the airbag case 26 so as to accommodate an inflater (not shown) for supplying an inflation gas to the airbag 24. The airbag case 26 is fixed to a stationary member, such as a cross member 34, via a support member 32 and by means of a bolt and nut 36.

As shown in FIG. 5, a fracture groove 38 extending in the lateral direction is formed in the above-mentioned fracture-opening section 221A of the panel member 221.

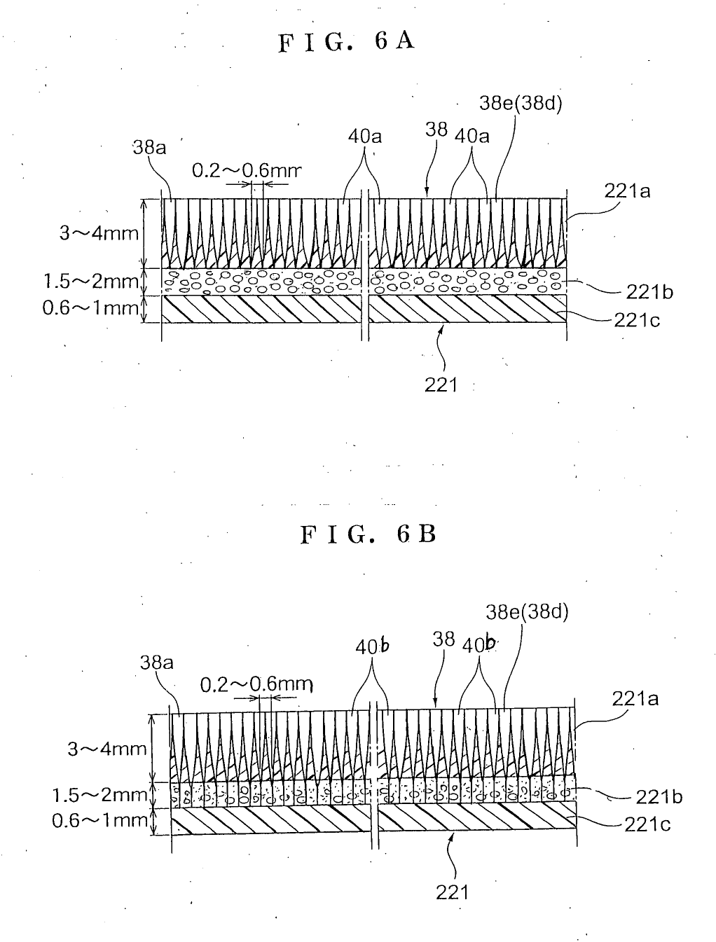

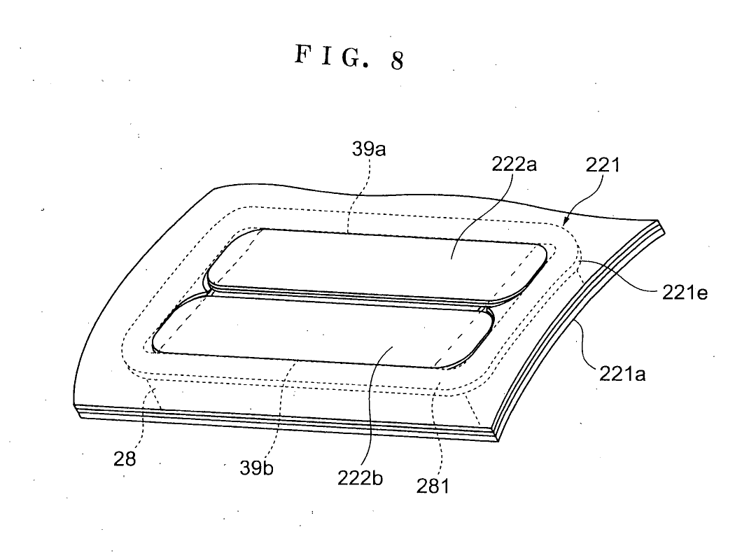

The fracture groove 38 is provided so as to form fracture-opening subsections 222a and 222b (see FIG. 8) in the fracture-opening section 221A in such a manner that the fracture-opening subsections 222a and 222b can be opened in the opposite directions (in the manner of a casement) when the fracture-opening section 221A is ruptured along the fracture groove 38 upon inflation of the airbag 24. As shown in FIGS. 6A and 6B, the fracture groove 38 is a groove which is formed on the reverse surface of the substrate 221a to a depth corresponding to the thickness of the substrate 221a or a depth slightly greater than the thickness of the substrate 221a, so that the groove reaches the foam layer 221b.

As shown in FIG. 5, the fracture groove 38, which forms the fracture-opening subsections 222a and 222b openable in the manner of a casement, is composed of a center fracture groove section 38a, two branch fracture groove sections 38b and 38c, and two pairs of side fracture groove sections 38d and 38e. The center fracture groove section 38a extends straight in the longitudinal direction (the direction parallel to the longer sides), and divides the fracture-opening section 221A into two sections in the top-bottom direction (the direction parallel to the shorter sides). The branch fracture groove sections 38b and 38c extend from the opposite ends of the center fracture groove section 38a, and assume a V-like shape. Each pair of side fracture groove sections 38d and 38e extends from the distal ends of the V-shaped branch fracture groove section 38b or 38c upward and downward, respectively, in FIG. 5 (the direction parallel to the shorter sides).

The center fracture groove section 38a may be offset from the boundary between the fracture-opening subsections 222a and 222b toward the fracture-opening subsection 222b, so that the area of the fracture-opening subsection 222a becomes larger than that of the fracture-opening subsection 222b.

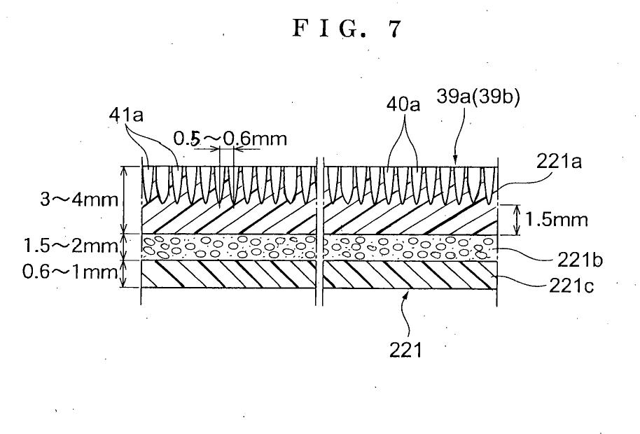

Hinge grooves 39a and 39b for pivoting motion of the fracture-opening subsections 222a and 222b are formed on the fracture-opening section 221A such that the hinge groove 39a extends between the ends of the side fracture groove sections 38d, which are located on the upper side of the center fracture groove section 38a in FIG. 5, and the hinge groove 39b extends between the ends of the side fracture groove sections 38e, which are located on the lower side of the center fracture groove section 38a in FIG. 5. As shown in FIG. 7, the hinge grooves 39a and 39b are grooves which are formed on the reverse surface of the substrate 221a to a depth about half the depth of the fracture groove 38.

The fracture groove 38 is formed by forming successive small holes 40a, 40b along a predetermined line on the reverse surface of the panel member 221 through irradiation with a pulsed laser beam from the reverse surface of the substrate 221a, in such a manner that the small holes do not pass completely through the panel member 221 as shown in FIGS. 6A and 6B.

In the example shown in FIG. 6A, the fracture groove 38 is formed by means of a plurality of the small holes 40a which adjoin to each other and which have a depth corresponding to the thickness (3 to 4 mm) of the substrate 221a.

In the example shown in FIG. 6B, the fracture groove 38 is formed by means of a plurality of the small holes 40b which adjoin to each other and which pass through the substrate 221a and reach the foam layer 221b, so that the small holes 40b are not provided in the surface layer 221c.

Each of the small holes 40a and 40b has a shape resembling a tip end of a bombshell, so that the transverse cross-sectional area, which is the maximum at the opening at the reverse surface of the substrate 221a, decreases toward the foam layer 221b. The small holes 40a and 40b having such a shape can be formed through control of the number of pulses or irradiation time of a laser beam emitted from a laser.

The above-described hinge grooves 39a and 39b are formed by forming successive small holes 41a along predetermined lines on the reverse surface of the panel member 221 through irradiation with a pulsed laser beam from the reverse surface of the substrate 221a, in such a manner that the small holes do not pass completely through the panel member 221 as shown in FIG. 7.

That is, as shown in FIG. 7, each of the hinge grooves 39a and 39b is formed by means of a plurality of the small holes 41a which are separated from each other and which have a depth ((3 to 4 mm)−1.5 mm), which is about half the thickness (3 to 4 mm) of the substrate 221a. For example, the small holes 41a are formed at intervals of 0.5 mm to 0.6 mm by means of a laser cutting process.

As shown in FIG. 5, the branch fracture groove sections 38b and the side fracture groove sections 38d and 38e of the fracture groove 38 overlap the flange portion 281 of the frame 28, which is bonded to the reverse surface of the substrate 221a to surround the fracture-opening section 221A.

The fracture groove 38 and the hinge grooves 39a and 39b are formed by use of an infrared laser beam having a diameter of 0.2 to 0.5 mm and a wavelength of 10.6 μm.

The thus-configured airbag apparatus 100 of the first embodiment functions in the following manner. Upon collision of the vehicle, an impact force caused by the collision is detected by an unillustrated sensor. A control unit including a CPU judges whether or not the detected impact force is equal to or greater than a predetermined value. When the control unit judges that the impact force is equal to or greater than the predetermined value, the control unit issues a signal for causing the inflater to generate a predetermined gas. The gas is fed to the airbag 24 so as to promptly inflate the airbag 24.

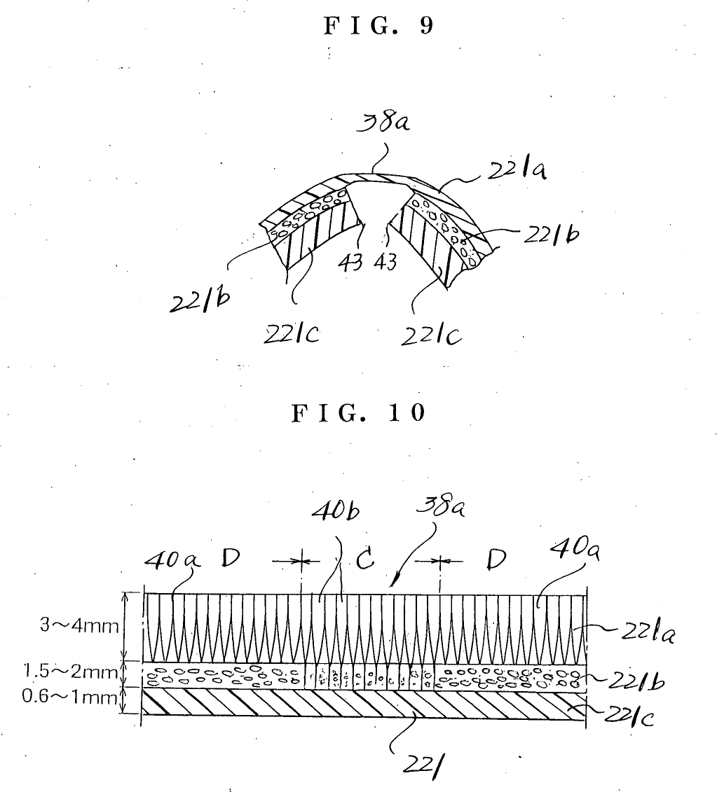

When the airbag 24 promptly inflates, a pressure generated at the beginning of the inflation acts on the fracture-opening section 221A via the reinforcement portions 303 of the reinforcement members 30. As a result, the fracture-opening section 221A is ruptured along the fracture groove 38, and the fracture-opening subsections 222a and 222b formed as a result of the rupture are opened toward the outside of the panel member 221 in the manner of a casement as shown in FIG. 8, while being turned about hinge grooves 39a and 39b. At this time, as shown in FIG. 9, rupture corner portions 43 of the substrate 221a ruptured along the fracture groove 38 are pressed against the surface layer 221c. Therefore, the foam layer 221b is ruptured by means of the rupture corner portions 43 and the impact force acing on the fracture-opening subsections 222a and 222b upon inflation of the airbag, and the surface layer 221c is expanded and ruptured along the fracture groove 38.

Simultaneously with this, the airbag 24 inflates and deploys toward the outside of the panel member 221 as the fracture-opening subsections 222a and 222b open in the opposite directions. Serving as a cushion, the inflated airbag 24 supports the passenger at his/her chest or head, thereby protecting the passenger from the impact force of collision.

In the airbag apparatus 100 according to the first embodiment, the fracture groove 38, which forms the fracture-opening subsections 222a and 222b in the fracture-opening section 221A of the panel member 221 composed of the substrate 221a, the foam layer 221b, and the surface layer 221c, is formed by successively forming the mutually adjacent small holes 40a or 40b along a predetermined line on the reverse surface of the panel member 221 by means of laser cutting from the reverse surface of the substrate 221a; the hinge groves 39a and 39b for pivoting motion of the fracture-opening subsections 222a and 222b are formed by successively forming the mutually separated small holes 41a along predetermined lines on the reverse surface of the panel member 221 by means of laser cutting from the reverse surface of the substrate 221a; and when the airbag 24 is inflated, the fracture-opening section of the panel member 221 is ruptured along the fracture groove 38, whereby the fracture-opening subsections 222a and 222b are caused to open in the manner of a casement about the hinge grooves 39a and 39b. Therefore, even though fracture grooves are not formed on the foam layer 221b or the surface layer 221c, by means of the rupture corner portions 43 of the substrate 221a ruptured along the fracture groove 38 and the impact force acing on the fracture-opening subsections 222a and 222b upon inflation of the airbag, the foam layer 221b and the surface layer 221c can be readily ruptured along the fracture groove 38. In addition, the opening of the fracture-opening subsections 222a and 222b in the manner of a casement upon inflation of the airbag 24 can be reliably performed in a well-balanced manner, and generation of a crack or breakage of the airbag cover 22, which would otherwise occur upon inflation of the airbag 24, can be prevented.

In particular, the above-described effect can be achieved without fail through employment of the reinforcement members 30, which reinforce the fracture-opening section 221A from the reverse surface side of the substrate 221a. Moreover, since fracture grooves are not required to be formed in the foam layer 221a and the surface layer 221c of the panel member 221, no sink mark or depression is formed on the surface of the surface layer 221c of the airbag cover 22. Therefore, the appearance of the airbag cover 22 is improved, and the aesthetic effect is improved.

In the first embodiment, the fracture groove 38 is composed of the straight center fracture groove section 38a, which divides the fracture-opening section 221A into two sections in the top-bottom direction (the direction parallel to the shorter sides); the branch fracture groove sections 38b and 38c, which extend from the opposite ends of the center fracture groove section 38a, and assume a V-like shape; and the pairs of side fracture groove sections 38d and 38e, which extend from the distal ends of the V-shaped branch fracture groove sections 38b and 38c in opposite directions. Therefore, at the opposite ends of the center fracture groove section 38a, the fracture-opening subsections 222a and 222b are ruptured along Y-shaped lines formed by the V-shaped branch fracture groove sections 38b and 38c and the side fracture groove sections 38d and 38e, so that the foam layer 221b and the surface layer 221c are ruptured along Y-shaped lines at the opposite ends of the center fracture groove section 38a. Therefore, the airbag can readily deploy without fail toward the outer side of the cover when the fracture-opening subsections 222a and 222b open in the manner of a casement.

In the first embodiment, if the frame 28 and the reinforcement members 30 are vibration-welded to the reverse surface of the substrate 221a before the foam layer 221b and the surface layer 221c are layered over and bonded to the substrate 221a, damage to the foam layer 221b of the panel member 221 is prevented.

In the first embodiment, when the center fracture groove section 38a is offset from the boundary between the fracture-opening subsections 222a and 222b toward the fracture-opening subsection 222b, so that the area of the fracture-opening subsection 222a becomes larger than that of the fracture-opening subsection 222b, the airbag 24 can reliably inflate and deploy toward a passenger in the front-passenger seat of the automobile, to thereby secure safety of the passenger.

In the first embodiment, as shown in FIG. 5, the branch fracture groove sections 38b and the side fracture groove sections 38d and 38e of the fracture groove 38 overlap the flange portion 281 of the frame 28, which is bonded to the reverse surface of the substrate 221a. Therefore, even when a pressing force is externally applied to the fracture-opening section 221A of the airbag cover 22, the fracture-opening section 221A hardly deforms; that is, the fracture-opening section 221A has increased strength.

In the first embodiment, the frame 28 and the reinforcement members 30 are each formed of a resin material, and are vibration-welded to the reverse surface of the panel member 221. Therefore, the productivity of the airbag cover 22 can be improved, and production cost can be reduced.

Notably, the fracture groove 38 and the hinge grooves 39a and 39b are not limited to grooves composed of small holes formed by means of laser cutting as shown in FIGS. 6A, 6B, and 7, and may be grooves which are continuously or intermittently formed on the back surface of the substrate 221a of the panel member 221 by use of a cutting tool or the like.

### Second Embodiment

A second embodiment of the present invention will next be described with reference to FIG. 10, which corresponds to FIGS. 6A and 6B.

The second embodiment differs from the first embodiment in the depth of the center fracture groove section 38a, which divides the fracture-opening section into two subsections.

That is, a central portion C of the center fracture groove section 38a with respect to the longitudinal direction is composed of small holes 40b having a depth slightly greater than the thickness of the substrate 221a so that the small holes 40b reach the foam layer 221b, and right-hand and left-hand end portions D of the center fracture groove section 38a with respect to the longitudinal direction are each composed of small holes 40a having a depth corresponding to the thickness of the substrate 221a. Since other structural components are identical to those of the first embodiment, they are denoted by the same reference numerals, and their description is omitted.

In the second embodiment, when the airbag inflates, the rupture of the panel member 221 starts from the central portion of the center rupture groove section, so that the panel member 221 is equally ruptured toward the left and right.

The method of bonding the frame 28 and the reinforcement members 30 to the reverse surface of the substrate 221a is not limited to vibration welding as mentioned in the above-described embodiments, and adhesive may be used to bond the frame 28 and the reinforcement members 30 to the reverse surface of the substrate 221a.

The present invention can be applied to airbag apparatuses from which the reinforcement members 30 are omitted.

Obviously, numerous modifications and variations of the present invention are possible in light of the above teachings. It is therefore to be understood that within the scope of the appended claims, the present invention may be practiced otherwise than as specifically described herein.

What is claimed is:

1. An airbag cover including a panel member for covering an airbag, the panel member comprising:
a substrate formed of a resin;
a foam layer formed of a resin and layered over and bonded to a surface of the substrate;
a surface layer layered over and bonded to a surface of the foam layer, wherein
the panel member has a fracture-opening section of an area required for inflation and deployment of the airbag;
a fracture groove is formed in the fracture-opening section so as to define two fracture-opening subsections which can be opened in the manner of a casement, the fracture groove being formed on a reverse surface of the substrate and having a depth corresponding to the thickness of the substrate or a depth slightly greater than the thickness of the substrate;
the fracture groove is composed of a straight center fracture groove section for dividing the fracture-opening section into the fracture-opening subsections, first side fracture groove sections extending from the opposite ends of the center fracture groove section in a first direction perpendicularly to the center fracture groove section, and second side fracture groove sections extending from the opposite ends of the center fracture groove section in a second direction opposite the first direction; and
first and second hinge grooves for pivotal motion of the fracture-opening subsections are formed on the reverse surface of the substrate such that the first hinge groove extends between the ends of the first side fracture groove sections and the second hinge groove extends between the ends of the second side fracture groove sections, each of the first and second hinge grooves having a depth less than that of the fracture groove.

2. An airbag cover according to claim 1, wherein the fracture groove further includes two branch fracture groove sections extending from the opposite ends of the center fracture groove section and assuming a V-like shape; and the first and second side fracture groove sections extend from distal ends of the V-shaped branch fracture groove sections.

3. An airbag cover according to claim 1, wherein the fracture groove and the hinge grooves are each composed of a plurality of small holes successively formed on the reverse surface of the substrate through irradiation with a laser beam.

4. An airbag cover according to claim 3, wherein small holes constituting the fracture groove adjoin to each other and have a depth corresponding to the thickness of the substrate or a depth slightly greater than the thickness of the substrate; and small holes constituting the hinge grooves are separated from each other and have a depth about half the thickness of the substrate.

5. An airbag cover according to claim 1, wherein the center fracture groove section is offset from the boundary between the fracture-opening subsections toward one of the fracture-opening subsection, so that the area of the other fracture-opening subsection becomes larger than that of the one fracture-opening subsection.

6. An airbag cover including a panel member for covering an airbag, the panel member comprising:
a substrate formed of a resin;
a foam layer formed of a resin and layered over and bonded to a surface of the substrate;
a surface layer layered over and bonded to a surface of the foam layer, wherein
the panel member has a fracture-opening section of an area required for inflation and deployment of the airbag;
a fracture groove is formed in the fracture-opening section so as to define two fracture-opening subsections which can be opened in the manner of a casement, the fracture groove being formed on a reverse surface of the substrate and having a depth corresponding to the thickness of the substrate or a depth slightly greater than the thickness of the substrate;
the fracture groove is composed of a straight center fracture groove section for dividing the fracture-opening section into the fracture-opening subsections, first side fracture groove sections extending from the opposite ends of the center fracture groove section in a first direction perpendicularly to the center fracture groove section, and second side fracture groove sections extending from the opposite ends of the center fracture groove section in a second direction opposite the first direction, wherein a central portion of the center fracture groove section with respect to the longitudinal direction has a depth slightly greater than the thickness of the substrate, and the remaining portions of the center fracture groove section have a depth corresponding to the thickness of the substrate; and
first and second hinge grooves for pivotal motion of the fracture-opening subsections are formed on the reverse surface of the substrate such that the first hinge groove extends between the ends of the first side fracture groove sections and the second hinge groove extends between the ends of the second side fracture groove sections, each of the first and second hinge grooves having a depth less than that of the fracture groove.

7. An airbag apparatus for a vehicle comprising:
an airbag;
an airbag cover composed of a panel member formed of a resin and adapted to cover the airbag;
an airbag case disposed behind the airbag cover and accommodating the airbag in a folded condition;
an inflater for supplying a gas to the airbag so as to inflate and deploy the airbag;
a frame formed of a resin and fixed to a reverse surface of the panel member, the frame surrounding a fracture-opening section of the panel member which section has an area required for inflation and deployment of the airbag, and supporting the airbag case; and
a pair of reinforcement members formed of a resin, the reinforcement member being supported by the frame and reinforcing the fracture-opening section from the reverse surface side thereof, wherein
the panel member includes a substrate formed of a resin, a foam layer formed of a resin and layered over and bonded to a surface of the substrate, and a surface layer layered over and bonded to a surface of the foam layer;
the panel member has a fracture-opening section of an area required for inflation and deployment of the airbag;
a fracture groove is formed in the fracture-opening section so as to define two fracture-opening subsections which can be opened in the manner of a casement, the fracture groove being formed on a reverse surface of the substrate and having a depth corresponding to the thickness of the substrate or a depth slightly greater than the thickness of the substrate;
the fracture groove is composed of a straight center fracture groove section for dividing the fracture-opening section into the fracture-opening subsections, two branch fracture groove sections extending from the opposite ends of the center fracture groove section and assuming a V-like shape, first side fracture groove sections extending from first distal ends of the V-shaped branch fracture groove sections in a first direction perpendicularly to the center fracture groove section, and second side fracture groove sections extending from second distal ends of the V-shaped branch fracture groove sections in a second direction opposite the first direction; and
first and second hinge grooves for pivotal motion of the fracture-opening subsections are formed on the reverse surface of the substrate such that the first hinge groove extends between the ends of the first side fracture groove sections and the second hinge groove extends between the ends of the second side fracture groove sections, each of the first and second hinge grooves having a depth about half the depth of the fracture groove.

8. An airbag apparatus for a vehicle according to claim 7, wherein the fracture groove and the hinge grooves are each composed of a plurality of small holes successively formed on the reverse surface of the substrate through irradiation with a laser beam.

9. An airbag apparatus for a vehicle according to claim 8, wherein small holes constituting the fracture groove adjoin to each other and have a depth corresponding to the thickness of the substrate or a depth slightly greater than the thickness of the substrate; and small holes constituting the hinge grooves are separated from each other and have a depth about half the thickness of the substrate.

10. An airbag apparatus for a vehicle according to claim 7, wherein the frame and the reinforcement members are vibration-welded to the reverse surface of the substrate before the foam layer and the surface layer are layered over and bonded to the substrate.

11. An airbag apparatus for a vehicle according to claim 7, wherein the center fracture groove section is offset from the boundary between the fracture-opening subsections toward one of the fracture-opening subsection, so that the area of the other fracture-opening subsection becomes larger than that of the one fracture-opening subsection.

12. An airbag apparatus for a vehicle comprising:
an airbag;
an airbag cover composed of a panel member formed of a resin and adapted to cover the airbag;. an airbag case disposed behind the airbag cover and accommodating the airbag in a folded condition;
an inflater for supplying a gas to the airbag so as to inflate and deploy the airbag;
a frame formed of a resin and fixed to a reverse surface of the panel member, the frame surrounding a fracture-opening section of the panel member which section has an area required for inflation and deployment of the airbag, and supporting the airbag case; and
a pair of reinforcement members formed of a resin, the reinforcement member being supported by the frame and reinforcing the fracture-opening section from the reverse surface side thereof, wherein
the panel member includes a substrate formed of a resin, a foam layer formed of a resin and layered over and bonded to a surface of the substrate, and a surface layer layered over and bonded to a surface of the foam layer;
the panel member has a fracture-opening section of an area required for inflation and deployment of the airbag;
a fracture groove is formed in the fracture-opening section so as to define two fracture-opening subsections which can be opened in the manner of a casement, the fracture groove being formed on a reverse surface of the substrate and having a depth corresponding to the thickness of the substrate or a depth slightly greater than the thickness of the substrate;
the fracture groove is composed of a straight center fracture groove section for dividing the fracture-opening section into the fracture-opening subsections, two branch fracture groove sections extending from the opposite ends of the center fracture groove section and assuming a V-like shape, first side fracture groove sections extending from first distal ends of the V-shaped branch fracture groove sections in a first direction perpendicularly to the center fracture groove section, and second side fracture groove sections extending from second distal ends of the V-shaped branch fracture groove sections in a second direction opposite the first direction, wherein a central portion of the center fracture groove section with respect to the longitudinal direction has a depth slightly greater than the thickness of the substrate, and the remaining portions of the center fracture groove section have a depth corresponding to the thickness of the substrate; and
first and second hinge grooves for pivotal motion of the fracture-opening subsections are formed on the reverse surface of the substrate such that the first hinge groove extends between the ends of the first side fracture groove sections and the second hinge groove extends between the ends of the second side fracture groove sections, each of the first and second hinge grooves having a depth about half the depth of the fracture groove.
